(19) United States
(12) Patent Application Publication
(10) Pub. No.: US 2024/0127397 A1
(43) Pub. Date: Apr. 18, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: EMI KAWAI, Kanagawa (JP)

(21) Appl. No.: 18/485,926

(22) Filed: Oct. 12, 2023

(30) Foreign Application Priority Data
Oct. 14, 2022 (JP) 2022-165391

(51) Int. Cl. G06T 3/40; G06T 5/00; G06T 5/50

(52) U.S. Cl. CPC G06T 3/4053; G06T 5/002; G06T 5/50; G06T 2207/20084; G06T 2207/20182; G06T 2207/20221; G06T 2207/30201

(57) ABSTRACT

An image processing apparatus includes one or more memories and one or more processors. The one or more processors and the one or more memories are configured to perform correction on an image and perform enlargement on the corrected image, wherein intensity of the correction in a case where the enlargement is performed is different from the intensity of the correction in a case where the enlargement is not performed.

### BACKGROUND

### Field of the Disclosure

The present disclosure relates to an image processing apparatus, and in particular, to an image processing apparatus configured to correct an image.

### Description of the Related Art

In recent years, with the spread of a smartphone and increase in functions of a digital camera, it is desirable to finely capture an image, in particular, an image including a person.

A technique for correcting an image has been proposed. For example, Japanese Patent Application Laid-Open No. 2016-148933 discusses a technique for changing intensity of image correction for each object person. Japanese Patent Application Laid-Open No. 2012-124715 discusses a technique for preventing, when image correction is performed, erroneous correction in a mode in which color changing processing is performed. The image can be corrected using these techniques to finely capture an image of the object.

In a case where enlargement processing is performed on an image, how the user views the image is changed. Even when the same correction is performed, the user may feel that the enlarged image is unnatural in some cases.

### SUMMARY

According to some embodiments of the present disclosure, an image processing apparatus includes one or more memories and one or more processors. The one or more processors and one or more memories are configured to perform correction on an image and perform enlargement on the corrected image, wherein intensity of the correction in a case where the enlargement is performed is different from the intensity of the correction in a case where the enlargement is not performed.

Further features of various embodiments will become apparent from the following description of exemplary embodiments with reference to the attached drawings.

### BRIEF DESCRIPTION OF THE DRAWINGS

FIG. 1 is a block diagram illustrating a configuration of a digital camera according to an exemplary embodiment of the present disclosure.

FIG. 2 is a system diagram illustrating a series of processes of enlargement processing according to the exemplary embodiment of the present disclosure.

FIG. 3 is a graph illustrating a relationship between resolution feeling setting and change in resolution feeling according to the exemplary embodiment of the present disclosure.

FIG. 4 is a graph illustrating a relationship between resolution feeling correction setting and composition rates according to the exemplary embodiment of the present disclosure.

FIG. 5 is a flowchart illustrating the series of processes of the enlargement processing according to the exemplary embodiment of the present disclosure.

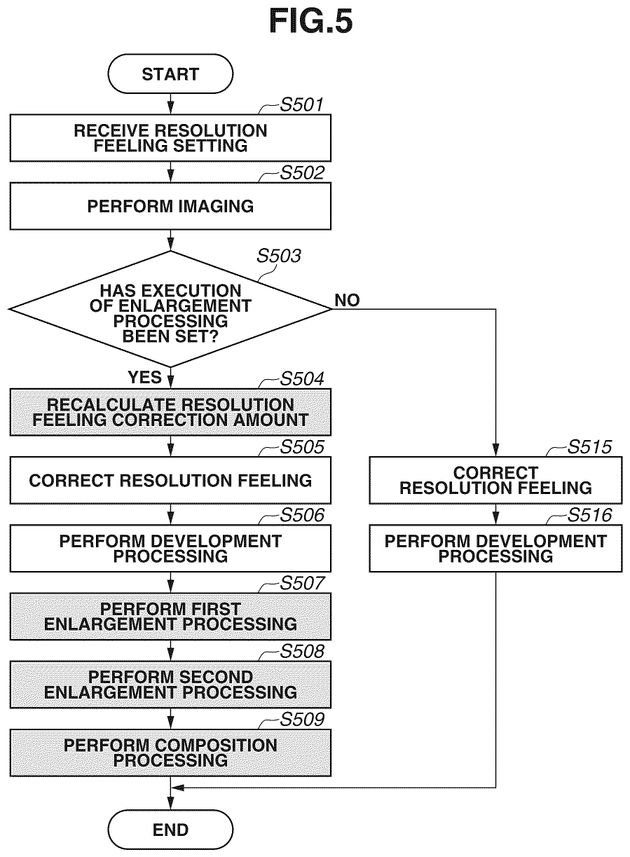

FIG. 6 is a graph illustrating calculation of a correction amount in skin glamorizing processing according to the exemplary embodiment of the present disclosure.

FIG. 7 is a graph illustrating an example of a method of determining the composition rates according to the exemplary embodiment of the present disclosure.

### DESCRIPTION OF THE EMBODIMENTS

An exemplary embodiment of the present disclosure is described with reference to drawings. The exemplary embodiment to be described below is merely an example, and some embodiments are not limited to the following exemplary embodiment.

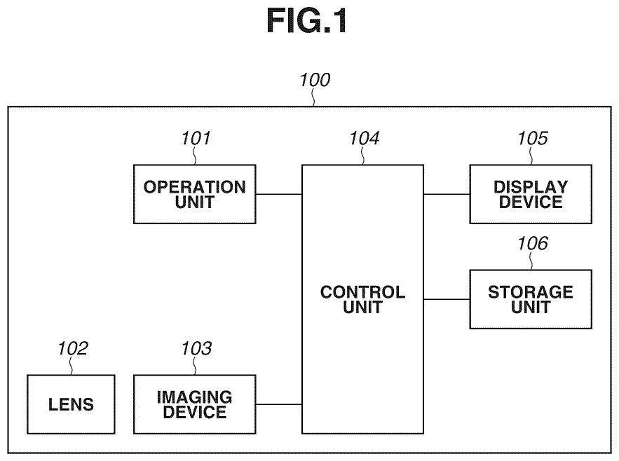

FIG. 1 is a block diagram illustrating a configuration of a digital camera according to the exemplary embodiment.

A digital camera 100 includes an operation unit 101, a lens 102, an imaging device 103, a control unit 104, a display device 105, and a storage unit 106. The operation unit 101 is an input device group including switches and a touch panel used by a user to operate the digital camera 100. The operation unit 101 includes a release switch for issuing an instruction to start imaging preparation operation and an instruction to start imaging, an imaging mode selection switch for selecting an imaging mode, direction keys, and a determination key. The lens 102 includes a plurality of optical lenses. A focus control lens is included among the lenses of the lens 102. The imaging device 103 is, for example, a complementary metal-oxide (CMOS) image sensor or a charge-coupled device (CCD) image sensor, and includes a plurality of arranged pixels (photoelectric conversion elements). A color filter of any of red (R), green (G), and blue (B) is provided in each of the pixels. The imaging device 103 is provided with peripheral circuits, such as an amplification circuit that processes signals obtained from the pixels. The imaging device 103 captures an object image formed through the lens 102, and outputs obtained image signals to the control unit 104. The control unit 104 includes a central processing unit (CPU), a memory, and other peripheral circuits, and controls the camera 100. A dynamic random access memory (DRAM) is one type of the memory included in the control unit 104. The memory is used as a work memory when the CPU performs various signal processing, and as a video random access memory (VRAM) when an image is displayed on the display device 105 to be described below. The display device 105 includes an electronic viewfinder, a rear liquid crystal display, and an external display of the camera 100, and displays information, such as setting values of the camera 100, a message, a graphical user interface such as a menu screen, a captured image, and the like. The storage unit 106 is, for example, a semiconductor memory card. A recording image signal (moving image data or still image data) is recorded as a data file in a predetermined format in the storage unit 106 by the control unit 104.

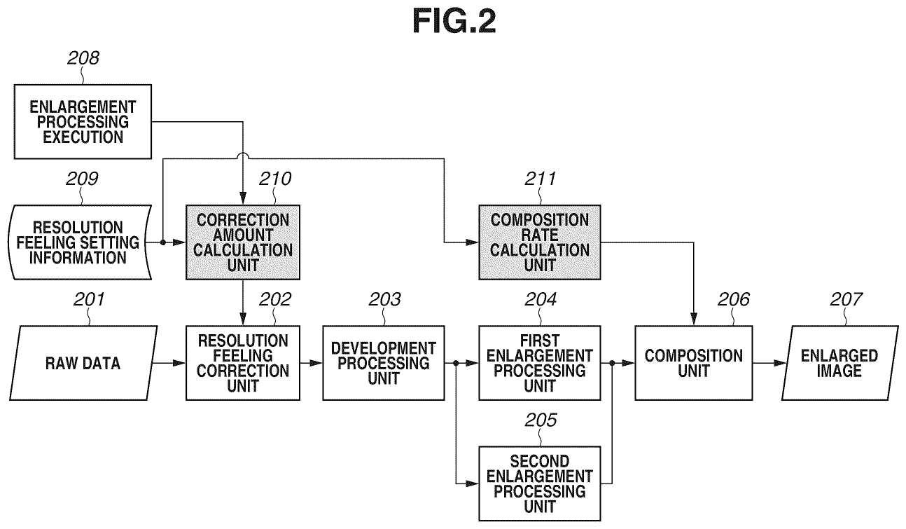

A series of processes of correction processing according to the present exemplary embodiment is to be described. FIG. 2 is a system diagram illustrating a series of processes of enlargement processing according to the present exemplary embodiment. Rectangular blocks in FIG. 2 indicate processing performed by the control unit 104. The series of processes illustrated in FIG. 2 indicates a series of processes from the correction processing to generation of a final enlarged image in a case where the enlargement processing is performed but as described below, the present exemplary embodiment is not limited to the case where the enlargement processing is performed, but includes a case where the enlargement processing is not performed.

A function of the enlargement processing illustrated in the system diagram of FIG. 2 is started when imaging is performed by the digital camera 100.

A resolution feeling correction unit 202 performs correction of resolution feeling on raw data 201 captured by the imaging device 103 based on a correction amount calculated by a correction amount calculation unit 210. The correction amount calculation unit 210 calculates the correction amount based on resolution feeling setting information 209 set by the user and enlargement processing execution 208. In other words, even when the user sets the same resolution feeling setting information 209, the correction amount calculated by the correction amount calculation unit 210 in the case where the enlargement processing is performed is different from the correction amount in the case where the enlargement processing is not performed.

The resolution feeling setting information 209 indicates information relating to resolution feeling setting set by the user. The resolution feeling setting specifically includes setting information for increasing resolution feeling, such as edge enhancement, setting information in noise reduction processing for reducing luminance noise and color noise even though the resolution feeling is weakened, and setting information in processing for adjusting the resolution feeling in a specific area of the image, such as a skin glamorizing mode. In each setting, intensity of the correction can be adjusted by the user setting. An example of a method of adjusting intensity of the resolution feeling correction includes a method of adjusting a threshold in smoothing filter processing in a case of the noise reduction processing.

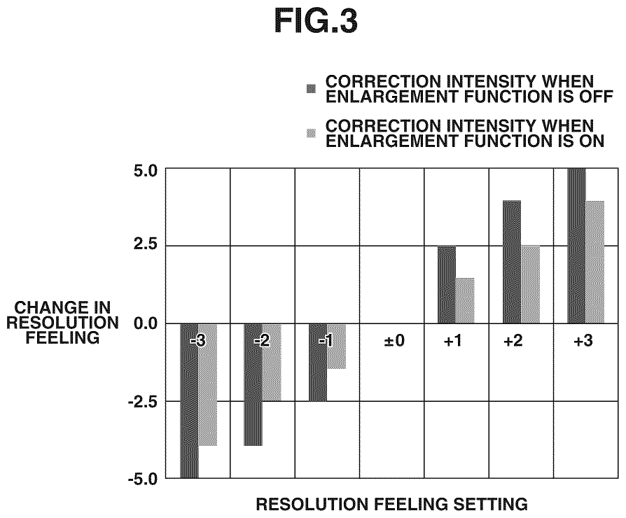

FIG. 3 is a graph illustrating a relationship between the resolution feeling setting and change in resolution feeling according to the present exemplary embodiment. In the graph illustrated in FIG. 3, a lateral axis indicates the resolution feeling setting, namely, the above-described resolution feeling setting information 209 set by the user. A vertical axis indicates change in resolution feeing after the correction, namely, change in resolution feeling when the correction is performed based on the correction amount calculated by the above-described correction amount calculation unit 210 while default setting is 1. In the graph illustrated in FIG. 3, a dark-colored bar indicates change in resolution feeling in the case where the enlargement processing is not performed, and a light-colored bar indicates change in resolution feeling in the case where the enlargement processing is performed. It is found from the graph illustrated in FIG. 3 that the resolution feeling in the case where the enlargement processing is performed is hard to be changed as compared with the case where the enlargement processing is not performed. This is because, in terms of the view as a result of combination of the correction based on the resolution feeling setting and the enlargement processing, in a case where setting to increase the resolution feeling is made, it is necessary to adjust the correction amount to be smaller than the correction amount in the setting so that the correction effect does not become excessive due to enhancement of the high-frequency signal by the enlargement processing.

A development processing unit 203 performs adjustment of color and luminance and the like after the image is converted into a color image including RGB color information. Even in normal imaging without performing the enlargement processing, the series of processes up to the processing by the development processing unit 203 is basically common.

The enlargement processing is performed after the development processing is completed. The enlargement processing may be performed only once by a well-known method, but in the present exemplary embodiment, a first enlargement processing unit 204 and a second enlargement processing unit 205 each enlarge the image to an optional magnification, thereby generating an enlarged image. The enlargement processing by the first enlargement processing unit 204 and the enlargement processing by the second enlargement processing unit 205 are performed by different methods. In the present exemplary embodiment, the first enlargement processing unit 204 performs the enlargement processing using deep learning (hereinafter, referred to as deep learning enlargement). On the other hand, the second enlargement processing unit 205 performs the enlargement processing using a filtering-based method, such as nearest neighbor interpolation, bicubic interpolation, and bilinear interpolation (hereinafter, only bicubic enlargement is described as example). A composition unit 206 combines outputs from the first enlargement processing unit 204 and the second enlargement processing unit 205. Before the composition unit 206 combines the outputs, composition rates of the respective enlarged images are determined by a composition rate calculation unit 211 based on the resolution feeling setting information 209. The composition unit 206 combines two types of enlarged images by using the composition rates calculated by the composition rate calculation unit 211, to generate a final enlarged image 207.

The processing by the composition rate calculation unit 211 is to be described in detail. The “composition rate” of a deep learning enlarged image and the “composition rate” of a bicubic enlarged image are important elements to obtain a high-quality enlarged image. This is because, with regard to the composite enlarged image 207 generated from the enlarged images, stable image quality with less adverse effect can be obtained as a usage rate of the bicubic enlarged image is increased, whereas the resolution feeling tends to be lost. In contrast, the resolution feeling is increased as a usage rate of the deep learning enlarged image is increased, whereas an adverse effect such as “excessive enhancement of high-frequency area” easily appears. Thus, the resolution feeling and stability have a trade-off relationship in each of the enlargement methods. The appropriate composition rates depend on the resolution feeding setting information 209. This is because “excess enhancement of high-frequency area” by the deep learning enlargement easily appears as the correction is performed to increase the resolution feeding of the image, and the correction effect of the resolution feeling may be different between the image before the deep learning enlargement and the image after the deep learning enlargement.

In the present exemplary embodiment, the composition rate calculation unit 211 calculates the composition rates corresponding to the correction intensity based on the resolution feeling setting information 209 set by the user, for example, after default composition rates are each determined to 50%. As for the method of calculating the composition rates, an exemplary relationship between a resolution feeling correction level and the composition rates is to be described.

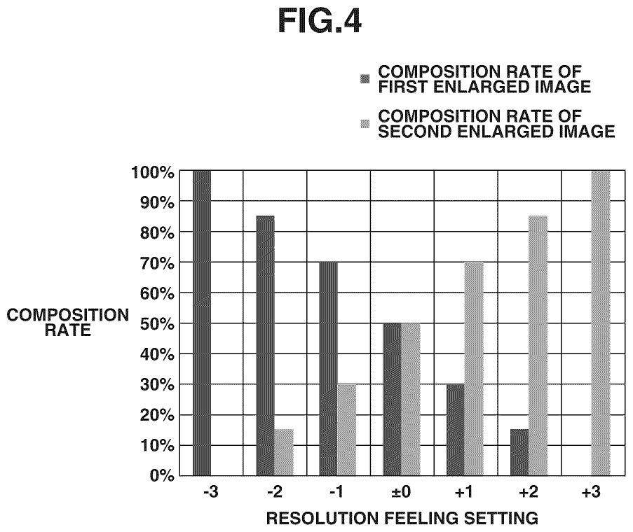

FIG. 4 is a graph illustrating a relationship between the resolution feeling correction setting and the composition rates according to the present exemplary embodiment. In the graph illustrated in FIG. 4, the resolution feeling correction setting in a lateral axis indicates correction intensity of the resolution feeling correction setting obtained from the resolution feeling setting information 209. As described above, the resolution feeling correction setting includes intensity setting of the noise reduction processing, and intensity setting of the skin glamorizing processing. The resolution correction level is an index totally indicating the correction intensity of the resolution feeling correction setting of the processing. The first enlarged image indicates the deep learning enlarged image, and the second enlarged image indicates the bicubic enlarged image. From FIG. 3, in the case where the correction is performed to increase the resolution feeling, the composition rate of the bicubic enlarged image is high, whereas in the case where the correction is performed to reduce the resolution feeling, the composition rate of the deep learning enlarged image is high.

For example, in a case where the user makes the setting to enhance the resolution feeling, the resolution feeling correction level in the graph illustrated in FIG. 3 is on a plus side. In this case, to prevent “excessive enhancement of high-frequency region”, adjustment is performed so as to reduce the composition rate of the deep learning enlarged image from the default composition rate.

The default composition rates as reference of the two types of enlarged images are both set to 50%, but the default composition rates may be set to different rates in consideration of deep learning resistance of default image quality. The default composition rate of one of the enlarged images may be set to zero.

The series of processes of the processing according to the present exemplary embodiment is to be described with reference to a flowchart.

In step S501, the control unit 104 receives the resolution feeling setting from the user through the operation unit 101.

In step S502, the control unit 104 receives an imaging instruction from the user through the operation unit 101, and the imaging device 103 performs imaging.

In step S503, the control unit 104 determines whether execution of the enlargement processing has been set by the user. In a case where execution of the enlargement processing has been set (YES in step S503), the processing proceeds to step S504. In a case where execution of the enlargement processing has not been set (NO in step S503), the processing proceeds to step S515.

In step S504, the control unit 104 recalculates the resolution feeling correction amount. The recalculation indicates calculation of the correction amount based on the relationship between the correction amount in the case where the enlargement processing is performed and the correction amount in the case where the enlargement processing is not performed as illustrated in the graph of FIG. 3, and the resolution feeling set by the user.

In step S505, the control unit 104 corrects the resolution feeling based on the resolution feeling correction amount calculated in step S504.

In step S506, the control unit 104 performs the development processing. The development processing is performed by the above-described development processing unit 203.

In step S507, the control unit 104 performs the processing by the above-described first enlargement processing unit (first enlargement processing).

In step S508, the control unit 104 performs the processing by the above-described second enlargement processing unit (second enlargement processing).

In step S509, the control unit 104 combines the image on which the first enlargement processing has been performed and the image on which the second enlargement processing has been performed.

In contrast, in the case where the enlargement processing is not performed, the control unit 104 performs, in step S515, the resolution feeling correction on the image captured by the imaging device 103 in step S502. In step S516, the control unit 104 performs the development processing on the corrected image.

The implementation method of the above-described present exemplary embodiment can be variously modified. As an example, different composition rates may be used for different areas in the same image.

For example, there is a user who wants to avoid enhancement of the high-frequency signal in a skin area of a person as compared with the other areas. To meet the needs of the user, the composition rate of the deep learning enlarged image and the composition rate of the bicubic enlarged image for the “skin area” are both set to 50%, and the composition rate of the deep learning enlarged image for areas other than the “skin area” is set to 100% in order to enhance the resolution feeling. This makes it possible to provide stable image quality only to a minimum necessary area and to improve the resolution feeling as much as possible. The “skin area” can be determined using a well-known image recognition method, for example, a method using a neural network. Alternatively, the “skin area” may be determined by designation by the user.

As the resolution feeling setting information 209, not the correction over the entire image but the correction for adjusting the resolution feeling only in a specific area of the image is considered. For example, setting of “skin glamorizing correction” in which a face area of a person in the image is detected and noise of only the face area is reduced is considered.

In a case where the enlargement processing by the above-described method of changing the composition rate of the skin area and the “skin glamorizing correction” are combined, the noise is reduced only in the face area by the setting of the skin glamorizing correction by the resolution feeling correction unit 202, and then the face area is combined at the composition rate at which the high-frequency signal is hard to be enhanced, by the composition unit 206.

Accordingly, the user may feel that the skin glamorizing correction effect of the face area in the enlarged image 207 is excessive.

This is because the composition unit 206 combines the face area of the deep learning enlarged image at the composition rate of 50% and the areas other than the face area of the deep learning enlarged image at the composition rate of 100%, and accordingly, the skin glamorizing effect of the face area is further relatively enhanced.

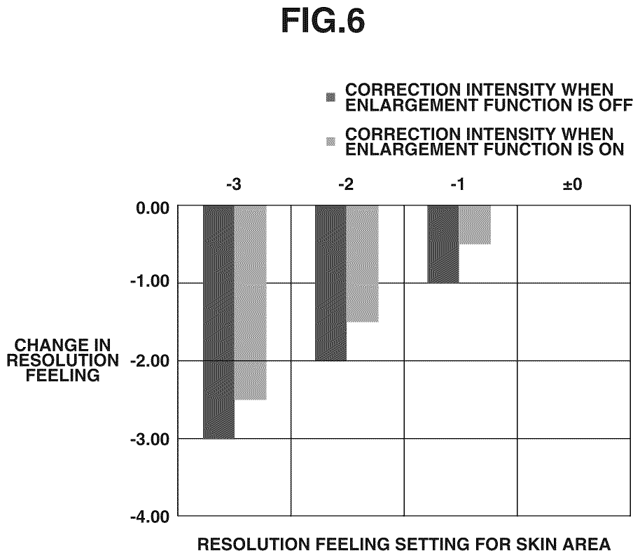

There are two methods for solving the above-described issue. As a first method, in the case where the skin glamorizing processing and the enlargement processing are combined, the correction intensity of the skin glamorizing processing is adjusted based on skin glamorizing intensity selected by the user. Calculation of the correction amount in the skin glamorizing processing at this time is to be described with reference to FIG. 6. FIG. 6 is a diagram illustrating calculation of the correction amount in the skin glamorizing processing according to the present exemplary embodiment. A lateral axis and a vertical axis in FIG. 6 are the same as the lateral axis and the vertical axis in FIG. 3, respectively. In the case where the enlargement processing is performed, change in resolution feeling is reduced, namely, the intensity of the skin glamorizing correction is weakened as compared with the case where the enlargement processing is not performed. This makes it possible to prevent the noise from being excessively reduced only in the skin area after the enlargement.

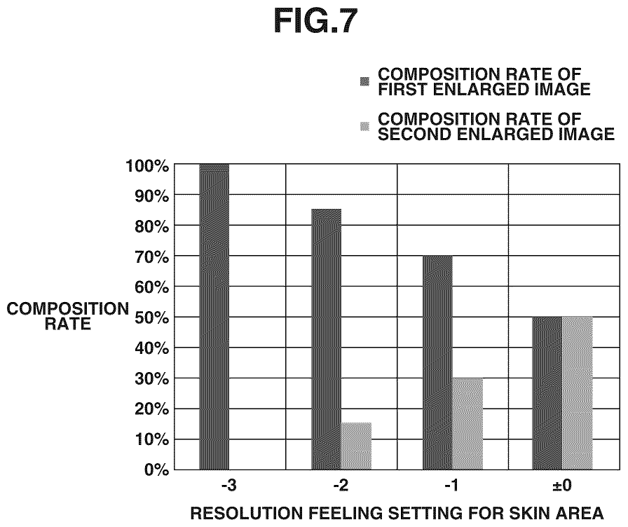

As a second method, in the case where the skin glamorizing processing and the enlargement processing are combined, the composition rate for the skin area is adjusted based on the skin glamorizing intensity selected by the user. FIG. 7 illustrates an example of a method of determining the composition rate at this time. FIG. 7 is a diagram illustrating the example of the method of determining the composition rate according to the present exemplary embodiment. For example, it is assumed that the resolution feeling correction level in the lateral direction in a case where the user sets “high skin glamorizing intensity”, namely, in a case where correction to reduce the resolution feeling of the skin area is performed corresponds to −3. At this time, the composition rate of the face area of the deep learning enlarged image is increased from 50% that is the default setting, to 100%.

The noise is prevented from being excessively reduced in the skin area of the composite enlarged image by increasing the composition rate of the face area of the deep learning enlarged image.

The size of the area where the resolution feeling is corrected is changed based on an occupancy area of the “skin area” in the image. For this reason, the composition rate may be changed based on the size of the “skin area”. The composition rate of a specific area other than the “skin area” may be similarly changed.

The function of the enlargement processing may be started based on the setting when imaging is performed by the digital camera 100, or may be started at a timing when an optional image is reproduced by the display device 105. In a case where the function of the enlargement processing is started at the timing of the reproduction, the series of processes in FIG. 2 can be applied as it is as long as raw data of the selected captured image remains. At this time, the correction by the resolution feeling correction unit 202 is performed based on the resolution feeling setting information 209 acquired from metadata of the raw data, and the processing by the development processing unit 203 is also performed based on the setting at imaging imparted to the metadata of the raw data.

The enlargement processing according to the present exemplary embodiment is applicable to a case where the raw data does not remain and developed image data is used. The composition rate can be calculated in a manner similar to the case where the raw data remains as long as the resolution feeling setting information is imparted to metadata of the developed image data, or the like.

According to the present exemplary embodiment, intensity of the resolution feeling correction can be adjusted based on whether the enlargement processing is performed.

The image processing apparatus according to the above-described exemplary embodiment can be implemented in an optional electronic apparatus in addition to the digital camera for individuals. Examples of such an electronic apparatus include a digital camera, a digital video camera, a personal computer, a tablet terminal, a mobile phone, a game machine, and transmission goggles used for augmented reality (AR) and mixed reality (MR), but the electronic apparatus is not limited to these examples.

Some embodiments of the present disclosure can be realized by supplying programs realizing one or more functions of the above-described exemplary embodiment to a system or an apparatus through a network or a storage medium, and causing one or more processors in a computer of the system or the apparatus to read out and execute the programs. And some embodiments of the present disclosure can be realized by a circuit realizing one or more functions (e.g., application specific integrated circuits (ASIC)).

### OTHER EMBODIMENTS

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2022-165391, which was filed on Oct. 14, 2022 and which is hereby incorporated by reference herein in its entirety.

What is claimed is:

1. An image processing apparatus comprising:
one or more memories; and
one or more processors, wherein the one or more processors and the one or more memories are configured to:
perform correction on an image; and
perform enlargement on the image on which the correction is performed,
wherein intensity of the correction in a case where the enlargement is performed is different from the intensity of the correction in a case where the enlargement is not performed.

2. The image processing apparatus according to claim 1, wherein the intensity of the correction in the case where the enlargement is performed is weaker than the intensity of the correction in the case where the enlargement is not performed.

3. The image processing apparatus according to claim 1, wherein the correction is performed on a partial area of the image.

4. The image processing apparatus according to claim 3, wherein the partial area is a face area.

5. The image processing apparatus according to claim 3, wherein the partial area is a skin area.

6. The image processing apparatus according to claim 1, wherein the correction glamorizes skin.

7. The image processing apparatus according to claim 1, wherein the correction reduces noise.

8. The image processing apparatus according to claim 1, wherein the one or more processors and the one or more memories are further configured to:
perform first enlargement using a neural network on the image on which the correction is performed, to generate a first enlarged image; and
perform second enlargement different from the first enlargement performed on the image on which the correction is performed, to generate a second enlarged image.

9. The image processing apparatus according to claim 8, wherein the one or more processors and the one or more memories are further configured to combine the first enlarged image and the second enlarged image.

10. The image processing apparatus according to claim 9, wherein a composition rate of the first enlarged image in a case where the intensity of the correction is first intensity is larger than the composition rate of the first enlarged image in a case where the intensity of the correction is second intensity greater than the first intensity.

11. The image processing apparatus according to claim 9, wherein a composition rate of the first enlarged image in a case where the intensity of the correction is first intensity is smaller than the composition rate of the first enlarged image in a case where the intensity of the correction is second intensity greater than the first intensity.

12. The image processing apparatus according to claim 10, wherein the one or more processors and the one or more memories are further configured to:
perform the correction on a partial area of the image, and
combine the first and second enlarged images based on an area of the partial area on which the correction is performed.

13. The image processing apparatus according to claim 10, wherein the one or more processors and the one or more memories are further configured to:
perform different correction on a plurality of areas of the image, and
combine the first and second enlarged images based on the correction performed on each of the plurality of areas of the image.

14. The image processing apparatus according to claim 9, wherein the second enlargement does not use the neural network.

15. The image processing apparatus according to claim 9, wherein the second enlargement uses at least any of a nearest neighbor method, a bicubic method, and a bilinear method.

16. The image processing apparatus according to claim 9, wherein the first enlarged image generated by performing the first enlargement on the image is more enhanced in high-frequency signal than the second enlarged image generated by performing the second enlargement on the image.

17. The image processing apparatus according to claim 9, wherein the first enlarged image generated by performing the first enlargement on the image is higher in resolution feeling than the second enlarged image generated by performing the second enlargement on the image.

18. The image processing apparatus according to claim 1, further comprising an imaging unit configured to capture an image,
wherein t the correction is performed on the image captured by the imaging unit.

19. An image processing method comprising:
determining whether an image will be enlarged;
in response to determining that the image will be enlarged, correcting the image according to a first intensity;
in response to determining that the image will be not enlarged, correcting the image according to a second intensity and
enlarging the corrected image,
wherein the first intensity is performed is different from the second intensity.

20. A non-transitory computer-readable storage medium that stores computer-executable instructions for causing a computer to perform an image processing method, the image processing method comprising:
performing correction on an image; and
performing enlargement on the image on which the correction is performed,
wherein intensity of the correction in a case where the enlargement is performed is different from the intensity of the correction in a case where the enlargement is not performed.
